(19) United States
(12) Patent Application Publication
(10) Pub. No.: US 2005/0128958 A1
(43) Pub. Date: Jun. 16, 2005

(54) Protocol for wireless multi-hop ad-hoc networks

(76) Inventor: Amen Hamdan, (US)

Correspondence Address: FROMMER LAWRENCE & HAUG LLP, 745 FIFTH AVENUE, NEW YORK, NY, 10151, US

(21) Appl. No.: 11/008,558

(22) Filed: Dec. 9, 2004

(30) Foreign Application Priority Data
Dec. 10, 2003 (EP) 03 028 292.5

(51) Int. Cl. H04Q 7/00; H04B 7/00; H04L 12/28

(52) U.S. Cl. 370/254; 370/310

(57) ABSTRACT

The invention relates to the field of service provisioning in wireless peer-to-peer networks organized according to the store-and-forward messaging principle, in particular to a service discovery protocol for providing low-profile, low-overhead service discovery information needed for determining the availability of requested remote services in a wireless multi-hop ad-hoc network.

### FIELD AND BACKGROUND OF THE INVENTION

The present invention generally relates to the field of wireless peer-to-peer networks, in particular to a service discovery protocol and a corresponding method for providing low-profile, low-overhead service discovery in-formation needed for determining the availability of requested remote services in a wireless multi-hop ad-hoc network designed for operation in e.g. home environments and personal usage scenarios.

Due to the widespread use of new personal network-enabled mobile devices (such as MD player and camcorder) and the emergence of near-ubiquitous communication infrastructure based on wired and wireless networks, it is becoming increasingly important to allow users and applications to interact with existing services without any need for configuration or administration. The key requirement for such a mechanism is to enable new services to advertise their existence and properties and allow service users to discover and utilize the services they need. These tasks are addressed by service discovery protocols.

Service discovery protocols which enable service providers to advertise capabilities to potential clients, thereby providing to clients and service providers a means for entering into a relationship, play a key role in mobile and wireless networks. Existing protocols addressing service discovery include e.g. IETF's Service Location Protocol (SLP), Sun Microsystems' Jini, Bluetooth's Service Discovery Protocol (SDP), Salutation—a nonproprietary service discovery protocol which is currently utilized by several shipping products—and the Universal Plug and Play (UPnP) protocol promoted by Microsoft.

Finding services within a wireless multi-hop ad-hoc network is a resource-consuming task with today's state-of-the-art service discovery protocols as these protocols often apply broadcast or centralized control structures which are not applicable to the special characteristics of wireless multi-hop ad-hoc networks. Therefore, it is necessary to implement some smart, distributed networking functionality where e.g. an application uses remote resources (services) to provide some functionality towards a user.

In the following, the requirements towards a service discovery protocol to be deployed within a home- or personal-type network scenario shall be explored, and a possible protocol for that purpose shall be discussed.

For service discovery in a wireless multi-hop ad-hoc network some boundary conditions have to be taken into account. Any of these boundary conditions translates to a requirement item that needs to be covered by any service discovery protocol that has to operate within a target environment. Even though a service discovery protocol might be operable in another scenario than the one given in a target environment, it should be tailored to provide optimal operation within said scenario.

Due to the ad-hoc nature of the target environment, any service discovery protocol applied has to be operational even with a varying network topology where nodes are allowed to permanently join or leave the network. In spite of having some indications on how stable a node's network affiliation is—stationary or mobile—, its presence can not be taken for granted over a certain period of time.

Hence, any service discovery protocol should operate without a single point of failure (i.e. without any central component).

In a typical multi-hop ad-hoc network sending network-wide broadcast messages is costly in terms of used resources. Furthermore, bandwidth is a scarce resource and its usage should be minimized while still allowing a high responsiveness to discovery requests. Any service discovery protocol needs to consider this by avoiding the transmission of broadcast messages and reducing the amount of background traffic.

Another problem that might probably occur in an ad-hoc networking environment refers to network partitions and rejoins. A service discovery protocol has to handle this scenario efficiently and quickly.

In e.g. a home network any configuration by the user side is to be avoided. Software can not easily be upgraded without having a mobile code. Once a system is deployed, it is assumed to be operational for a longer period of time.

As for every service discovery protocol there are some typical requirements that have to be fulfilled. For each of the following items it has to be ensured that they are working under the above-stated boundary conditions.
Discovery of services: The very basic (and most obvious) requirement towards a service discovery protocol is to find any service of interest on the network. For some applications it is additionally required to keep an up-to-date view on the services on the network, thus demanding not only a discovery of service but also monitoring services and possibly their states. Furthermore, it should be possible to perform the query for services in a diffuse way, e.g. by finding a service by only giving an incomplete list of attributes that the service shall met.
Consistent and simple service description: As a part of the service discovery not only communication protocols but also data formats need to be specified. These formats are needed to prevent inconsistencies and ambiguities.
Fast setup and reaction to changes: Any service discovery protocol shall strive to provide quick responsiveness to changes in the network, i.e. a newly introduced service shall be made known as fast as possible to other nodes. Minimizing the latency will influence the perceived agility of the network (eventually by the user). This problem is especially evident in an ad-hoc environment where changes in the network topology are probably more the rule than the exception.

The problem to be solved can be very quickly described as the need to implement the required functionality as described above under the aforementioned boundary conditions.

### BRIEF DESCRIPTION OF THE STATE OF THE ART

Publish/subscribe- versus request/response-type service discovery protocols: When a publish/subscribe-type discovery protocol is applied, the network registers at a certain source or channel for dedicated service discovery messages. These messages are then sent in case a service becomes available or is no longer present, respectively. In a request/response-type discovery protocol a certain service is only searched if it has explicitly been requested by a certain client. Information on service availability is not announced. Hence, monitoring the availability of services requires periodic polling of all (or some specific) services in the network. Of course, hybrid approaches (mixtures of the above two) are also conceivable.

a) Universal Plug and Play (UPnP)

Universal Plug and Play is an open network architecture developed by an industry consortium leaded by Microsoft Corporation. UPnP offers ad-hoc peer-to-peer network connectivity of different services and devices.

b) Service Location Protocol (SLP)

The Service Location Protocol (see http://www.srvloc.org/) is the service discovery protocol proposed by the IETF. It is being developed by the Srvloc Working Group and is vendor-independent. SLP is designed for TCP/IP networks and intended to become the standard in the Internet community. The current version of SLP is SLPv2. The SLP architecture is basically composed of three members: User Agents (UAs), Service Agents (SAs), and Directory Agents (DAs).

c) Salutation

The Salutation architecture is an industry consortium's solution to the service discovery and utilization problem. The architecture provides a standard method for applications, services and devices—so-called Networked Entities—to advertise their capabilities or request the desired ones. It is claimed to be processor-, operating-system and communication-protocol independent. Its key piece is the Salutation Manager (SLM). Every Networked Entity has an SLM or uses a remote SLM by means of the Remote Procedure Call (RPC) protocol. The SLM provides services and clients with a transport-independent interface (SLM-API). A Networked Entity can act as service, client or both. The different SLMs communicate among themselves using the Salutation Manager Protocol, which is based on remote procedure calls.

d) Jini

Jini is a service-oriented Java-based architecture (infra-structure and programming model) developed by Sun Microsystems. The architecture of Jini is based on the Jini Lookup Service (JLS) component. The services have to locate a JLS server—by using the discovery protocol—and then register themselves in the JLS by using a join protocol. The clients also discover a JLS and can then query it about the available services. The matching between queries and services can be made comparing Java interfaces or a list of characteristic attributes. Each service will be maintained by the JLS only for a certain period of time, i.e. for a lease period. In this way services which are not registered are eliminated from the register.

e) Bluetooth

A Bluetooth-enabled personal area network (PAN) consists of large-sized multi-hop networks in which mobile devices can communicate not only via a master node with other mobile devices located in a single piconet but also with wireless nodes which can be reached via a multiplicity of intermediate nodes. Mobile devices are thus able to communicate and use services provided by other mobile devices or infrastructure systems. To allow mobile terminals to use these services, service providers have to publish all available services together with some basic configuration information, and service users have to be equipped with means for searching these services and selecting a specific service provider. The Bluetooth Service Discovery Protocol (SDP) thereby defines how a Bluetooth client's application shell acts to discover services offered by available Bluetooth servers and their characteristics. SDP thereby allows client applications to access services by using other discovery protocols such as SLP, Salutation, etc., but it does not need them. The protocol defines how a client terminal can search for a remote service based on specific attributes without knowing anything about the availability of said service. It provides means for discovering new services that become available when a client terminal enters an area where a Bluetooth server is operating. SDP also provides functionality for detecting when a service is no longer available.

A device containing an SDP client can search services specifying its class or some of its attributes, and it also can retrieve services without knowing its characteristics. In turn, a remote SDP server will respond to these inquiries. Devices must be aware of the availability of new services and know about the unavailability of known ones. The use of intermediary agents as caches to improve the efficiency of the system is allowed.

US 2002/0120750 A1 describes a method, a wireless network device and a computer program product for performing service discovery in a pervasive wireless local area network, e.g. in an ad-hoc Bluetooth PAN consisting of a number of multi-hop networks.

U.S. Pat. No. 6,397,061 B1 refers to a method and apparatus for reprioritizing data transfer in a short-range mobile ad-hoc network (MANET) applied to a wireless communication device capable of communicating with a local wireless network within a predetermined communication range.

A communication device and a software for operating multimedia applications in at least one communication network is described in US 2001/0003191 A1.

EP 1 227 689 A1 pertains to an entry gateway server provided to support mobile devices in the discovery process of local services.

EP 1 022 876 A1 refers to a method for advertising services offerings in wireless local area networks comprising at least two mobile terminals and an apparatus for exchanging service information with other mobile terminals.

A scheme and an apparatus for distinguishing services offered by a service-providing device in adjacency of the apparatus from services offered by a service-providing device not being in the apparatus' adjacency is described in EP 1 024 628 A1.

An advanced system and method for dynamically discovering, provisioning and accessing host services on wireless data communication devices needed for sending a service book to a mobile device is described in WO 02/084975 A2.

WO 02/23826 A2 pertains to a service framework supporting service discovery and connection, in particular to an information appliance system with a user device comprising a client platform that includes a service framework to discover and connect with a variety of services, both remote and local, transient and persistent, and to disconnect from said services when they are no longer of interest or become unavailable.

WO 02/45382 A2 is directed to a method and device for providing a service record for an application (e.g. a legacy application) running on a virtual serial port of a wireless transceiver device, such as a Bluetooth-enabled device.

OBJECT OF THE PRESENT INVENTION

It is the object of the present invention to propose a technology for improving peer-to-peer service discovery in wireless multi-hop ad-hoc networks.

This object is achieved by means of the features of the independent claims. Advantageous features are defined in the subordinate claims. Further objects and advantages of the invention are apparent in the detailed description which follows.

### SUMMARY OF THE INVENTION

The present invention is basically dedicated to a service discovery protocol and a corresponding method for providing low-profile, low-overhead service discovery in-formation needed for determining the availability of requested remote services in a peer-to-peer-based wireless multi-hop ad-hoc network organized according to the store-and-forward messaging principle which is designed for operation in e.g. home environments and personal usage scenarios.

According to one embodiment of the present invention, received service announcement messages are transmitted, said messages referring to remote services offered by service providers within said network. Thereby, outdated messages which are identical with old service announcement messages that have already been received by this peer are discarded, and new service announcement messages are accumulated in a local message pool assigned to said peer and sorted according to their potential relevance before being propagated to said neighboring peers. First, each service announcement message received by this peer is tagged with a relevance value. After that, relevance values of all service announcement messages stored in said local message pool are summed up, thus yielding a cumulative relevance value. Once this cumulative relevance value exceeds a predefined relevance threshold value, all service announcement messages stored in said local message pool are aggregated and sent to all neighboring peers of said peer.

### BRIEF DESCRIPTION OF THE DRAWINGS

Further advantages and possible applications of the present invention result from the subordinate claims as well as from the following description of different embodiments of the present invention, accompanied by the following drawings:

FIG. 1 shows different characteristic features, advantages and disadvantages of conventional service discovery mechanisms and protocols according to the state of the art,

FIG. 2 is a diagram showing different peer protocol layers used for the handling of a metadata-based service description according to the present invention,

FIG. 3 is a first UML message sequence chart, which shows the interactions for registering a remote service according to the present invention,

FIG. 4 is a second UML message sequence chart, which shows the interactions for registering a local service according to the present invention,

FIG. 5 is a third UML message sequence chart, which shows the interactions for handling a service message indicating the availability of a remote service according to the present invention,

FIG. 6 is a fourth UML message sequence chart, which shows the interactions for deregistering a local or remote service according to the present invention,

FIG. 7 is a UML state chart illustrating the service discovery mechanism executed by the service discovery protocol 208 according to the present invention, and

FIG. 8 is a UML class diagram showing the classes for an object-oriented implementation of the service discovery protocol according to the present invention.

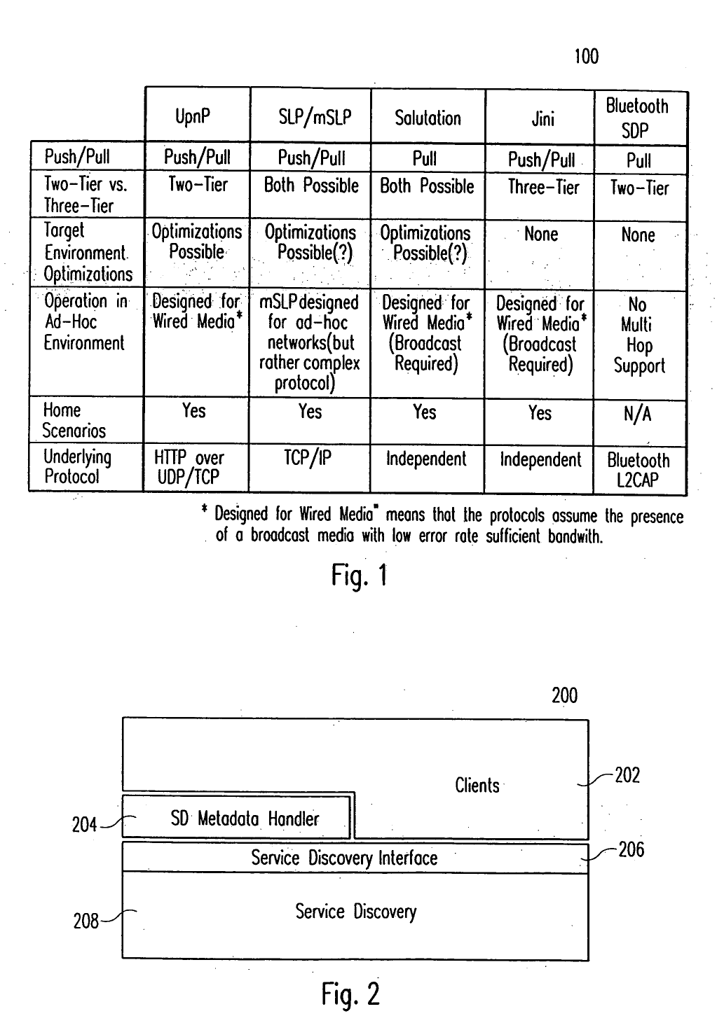

### DETAILED DESCRIPTION OF THE PRESENT INVENTION

In case a peer requires a certain service for any of the client applications and/or services it is running, it has basically two different possibilities: proactively querying for any service which might be of interest to a user or listening to some channels for service announcements.

To find a specific service with given attributes in the network, a reactive service discovery mechanism can be executed. For this purpose, the data link control (DLC) layer already implements some low-level service discovery means. To utilize this functionality, the following three-phase approach is proposed:
1. First, a local service table is queried for a specific service of interest.
2. If locally none is available, a DLC service discovery protocol is executed.
3. Once some services of interest are known, more detailed information on them is retrieved and forwarded to the requesting peer.

To further enhance the responsiveness of the applied service discovery mechanism, not only proactive service querying but also service announcement is supported. The design target of the proposed service discovery protocol is to provide some robust and efficient service announcement means while minimizing the number of messages to be sent. Thereby, broadcast messages are avoided as they are rather costly in a wireless ad-hoc networks.

According to one embodiment of the present invention, every peer Nᵢ implements a so-called service announcement message pool Pᵢ. Thereby, any service announcement message Mᵢₖ received by this peer Nᵢ is tagged with a relevance value rᵢₖ. After that, all relevance values rᵢₖ in the pool are summed up, thus yielding a cumulative relevance value

$${R}_{i} := {\sum }_{k = 0}^{{K}_{i} - 1} {r}_{ik} with {r}_{ik} ∈ {0}_{} , \qquad ( 1 )$$

wherein Kᵢ denotes the total number of service announcement messages Mᵢₖ stored in said peer's pool Pᵢ. Once this cumulative relevance value Rᵢ exceeds a predefined threshold value R_{th,i}, all messages in the pool Pᵢ are aggregated and sent to any neighboring peer N [symbol] ( [symbol] ≠i). Said relevance values rᵢₖ can be very small for service announcements that are not of high importance and higher for more important ones. The speed with which messages are distributed in the network can thus be controlled in a fine-grained way.

In case the applied transmission media support one-hop broadcasting, a single service announcement message pool Pᵢ can be used for the entire neighborhood of a wireless peer Nᵢ. If this is not the case or in case the message delivery should be controlled in a more fine-grained manner, another pool Pⱼ can be implemented. This allows e.g. to set the threshold values R_{th,i} of pools Pᵢ assigned to mobile peers Nᵢ to a higher value than the threshold values R_{th,j} of pools Pⱼ assigned to stationary peers Nⱼ. It is also possible to define a non-fixed threshold value R_{th,i}, which means a time-variant threshold function R_{th,i}(t) that can be changed according to external conditions. For example, when determining that a neighboring peer N [symbol] is running low on energy and/or other information concerning varying resource availability within said network and/or changing link characteristics between a peer Nᵢ and its neighboring peer N [symbol] , the threshold value R_{th,i} of the according service announcement message pool Pᵢ of peer Nᵢ is increased in order to avoid sending unnecessary messages Mᵢₖ to the neighboring peer N [symbol] .

While the cumulative relevance values Rⱼ:=Σₖrⱼₖ on stationary peers Nⱼ must not exceed a predefined threshold value R_{th,j}, mobile peers Nᵢ are free to choose any value for their threshold value R_{th,i}. Setting this threshold value R_{th,i} to “infinite” would be equal to not sending any messages at all while a value of zero would force every message Mᵢₖ to be resent immediately.

The basic protocol for propagating service announcement messages is rather simple in order to allow an efficient execution. In principle, the following steps need to be executed by any peer participating in the service announcement procedure according to the present invention:
1. Any service announcement is done with an additional integer relevance parameter rᵢₖ as well as a real-valued relevance degeneration rate dᵢₖ between 0 and 100%.
2. If a service announcement message Mᵢₖ has been seen before on a peer Nᵢ, it is discarded. In any other case, the message is locally stored on this peer by putting it into a pool Pᵢ of received service announcement messages Mᵢₖ.
3. After that, all relevance values rᵢₖ assigned to service announcement messages Mᵢₖ stored in this pool Pᵢ are added, thus yielding a cumulative relevance value Rᵢ:=Σₖrᵢₖ. If the cumulative relevance value Rᵢ exceeds a predefined threshold value R_{th,i}, the service announcement messages Mᵢₖ are aggregated and sent to all peers in the neighborhood of said peer Nᵢ. The same happens if the number Kᵢ of service announcement messages Mᵢₖ in the pool Pᵢ exceeds a certain number threshold K_{th,i} or if the time Δtᵢₖ passed since the reception of the last service announcement message Mᵢₖ exceeds a predefined time period threshold Δt_{th,i}. These conditions can be summarized as follows:

$$∀ i : [ ( {R}_{i} > {R}_{th , i} ) ⋁ ( {K}_{i} > {K}_{th , i} ) ⋁ ∃ k : ( Δ {t}_{ik} > Δ {t}_{th , i} ) ] ⇒ Send {{⋃}^{{K}_{i} - 1}}_{k = 0} {M}_{ik} from {N}_{i} to all neighbors {N}_{l} ( l \neq i ) . \qquad ( 2 )$$
4. Any peer Nᵢ that receives a service announcement message Mᵢₖ puts it into its local pool Pᵢ. Furthermore, said peer Nᵢ recalculates the relevance value rᵢₖ of the incoming message by subtracting the percentage of degeneration given by the relevance degeneration rate dᵢₖ from the respective relevance value rᵢₖ:

$${r}_{{ik}^{′}} := {r}_{ik} \cdot ( 1 - \frac{{d}_{ik} [ \% ]}{100} ) ∈ {0}_{+}^{} for {r}_{ik} ∈ {0}_{} and {d}_{ik} ∈ [ 0 \% , 100 \% ] . \qquad ( 3 )$$

The degeneration of the relevance value rᵢₖ allows to create messages Mᵢₖ that initially have a high relevance value rᵢₖ (and are thus quickly sent throughout the network) but get “less important” after some hops. Thus, service announcement messages Mᵢₖ are quickly spread to near-by peers but only slowly propagated to peers farther away.

Every message Mᵢₖ that is sent contains a service identifier (or service description), a message identifier and the address of the peer N_{H} hosting the service. The message identifier is created from a peer internal counter that is incremented after a message Mᵢₖ was tagged.

Whenever a peer Nᵢ receives a new message Mᵢₖ, it checks for the lastly seen message M_{i,k-1} with the given service identifier from the given peer. If the stored message identifier is newer than the one of the new message Mᵢₖ, this new message is discarded.

Additionally, each available service is associated with a lease timeout before which the available service has to be re-announced. This mechanism is used to avoid old entries in the service tables.

Service availability announcements are triggered when a service which has to be made known to client terminals connected to the wireless multi-hop ad-hoc network registers itself on a local peer Nᵢ. Thereby, any service availability announcement message Mᵢₖ is not only put into the peer's service announcement message pool Pᵢ but also causes an update of the local service table.

In the same sense, the availability of a service has to be made known to other peers, whereas the loss of a service has to be propagated throughout the entire network. In principle, the reasons for announcing service loss will mainly be that a service is unregistered at a peer. The case that a peer is no longer present in the network and thus services hosted on that peer are also lost is extra handled by monitoring the availability of wireless peers. The overall process for announcing a message is the one described above.

In order to remove outdated entries from peers which are no longer present in the network, a mechanism for indicating peer loss is added to the service discovery protocol. This mechanism supports the leasing mechanism already introduced above.

Once a new neighboring peer Nⱼ becomes visible, service tables and management data of the services offered by this peer (e.g. its message counter) are requested. The returned services are checked whether they have already been handled. If this is not the case, they are added to the local message pool Pᵢ of the respective peer Nᵢ. Thereby, network fluctuations are used to furthermore trigger message exchanges and to contribute to the overall availability of messages in the network. To avoid sending unnecessary messages, negotiation procedures as described below can be applied.

Since message overheads caused by said negotiation procedure should be avoided, a new peer joining said network is only allowed to clone the state of one (or some) of its neighbors.

So far we only described a pro-active service presence information dissemination. Of course, the given protocol can also be used to forward requests for services to other nodes.

Whenever the pool content is sent to anyone of a wireless peer's neighbors (or to a multiplicity of them), a short outline of the messages to be sent will be delivered. The information sent includes (at least) the service identifier, the address of the peer NH hosting the service and the message identifier. With this information any peer can decide if the message is of interest to it or not. Accordingly, there are the following options available in case peer Nᵢ offers peer Nᵢ₊₁ a message Mᵢₖ:
1. In case this message Mᵢₖ is not of interest for peer Nᵢ₊₁, it can request peer Nᵢ to delete the message.
2. If said message Mᵢₖ is possibly of interest to peer Nᵢ₊₁ but Nᵢ₊₁ does not yet want to receive it (i.e. because peer Nᵢ₊₁ is going to initiate a sleep mode and does not process further messages), it can request peer Nᵢ to store the message for later delivery.
3. It might also be possible that peer Nᵢ₊₁ has an updated message M_{i+1,k} that makes the one (Mᵢₖ) of peer Nᵢ obsolete (e.g. peer Nᵢ wants to send a service announcement, but peer Nᵢ₊₁ already knows that the respective service is no longer available). In this case, peer Nᵢ₊₁ provides peer Nᵢ with the updated message M_{i+1,k}.

Within a wireless multi-hop ad-hoc network a number of services can be available at the same time. Some of them might be seen as a conglomerate service (e.g. the television control and the surround control services might be seen as one home entertainment service). In case a service user wants to find such a conglomerate service, it specifies such within a query. Decomposing the conglomerate service into particular services and discovering them within the network is then done by the service discovery protocol according to the present invention. For this purpose, a request for the conglomerate service is spread within the network, and each peer wishing to contribute to it will send back a corresponding response. These responses are collected at the requesting peer, and a check is done if the conglomerate service can be created or not.

As basis for the service description only key/value pairs are supported. They allow describing a service by assigning key (attribute) values. Since only the basic service discovery mechanism is implemented by the given protocol, this information will be sufficient. In contrast to other service description languages, e.g. the one in UPnP, information like event or state description is intentionally left out to minimize overhead. To still provide such a functionality towards higher layers, an additional component is introduced: the Service Discovery (SD) Metadata Handler 204. This component can mediate between more complex higher-layer service description means, as e.g. the one of UPnP, and the proposed service discovery protocol 208 according to the present invention (see FIG. 2). For this purpose, it extracts the core service description attributes to pass them to the service discovery protocol layer. Once the service discovery protocol has found some services, it correspondingly re-assembles the answer in the expected format. If required, such a meta-data handler 204 could be deployed to map various service discovery protocols to the given service discovery protocol 208.

Even though the protocol is especially designed for the purpose of service discovery, the basic communication scheme might also work well for other data such as e.g. network status information, device presence messages, event propagation or any kind of data that do not have real-time constraints in terms of data delivery. Such kind of data could be (among others): distributed routing information, distributed information to support/enable QoS provisioning, network status information, (instant) messaging data, sensor data, peer status information, etc.

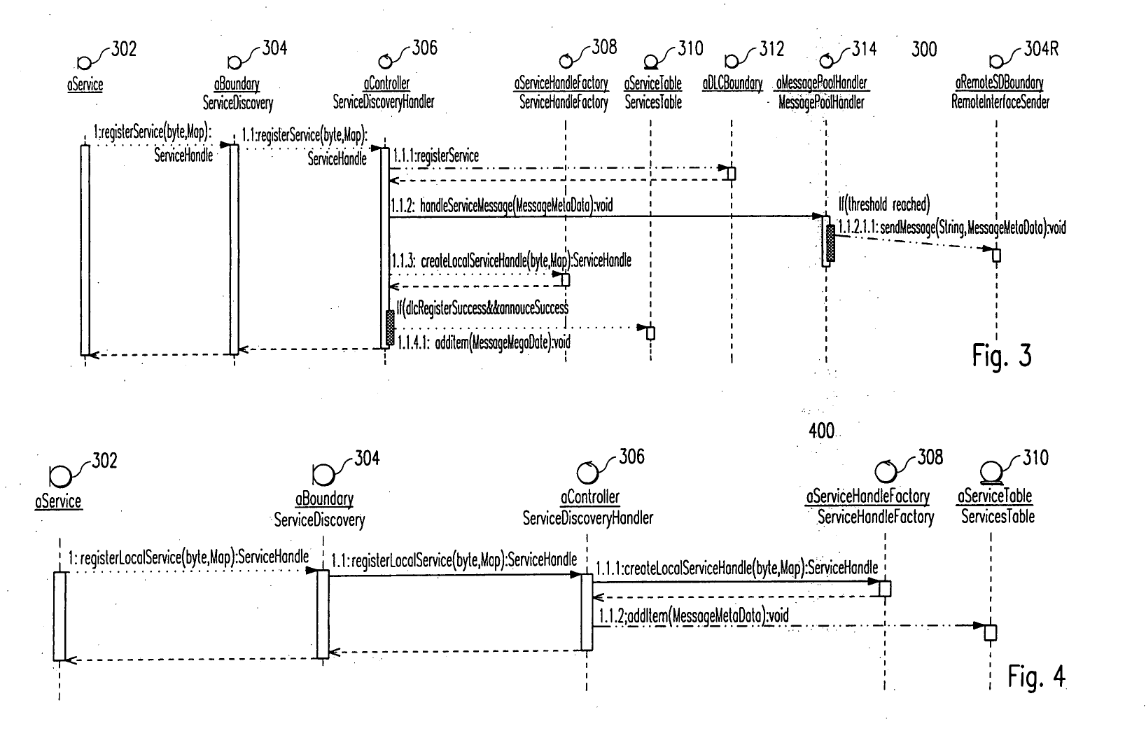

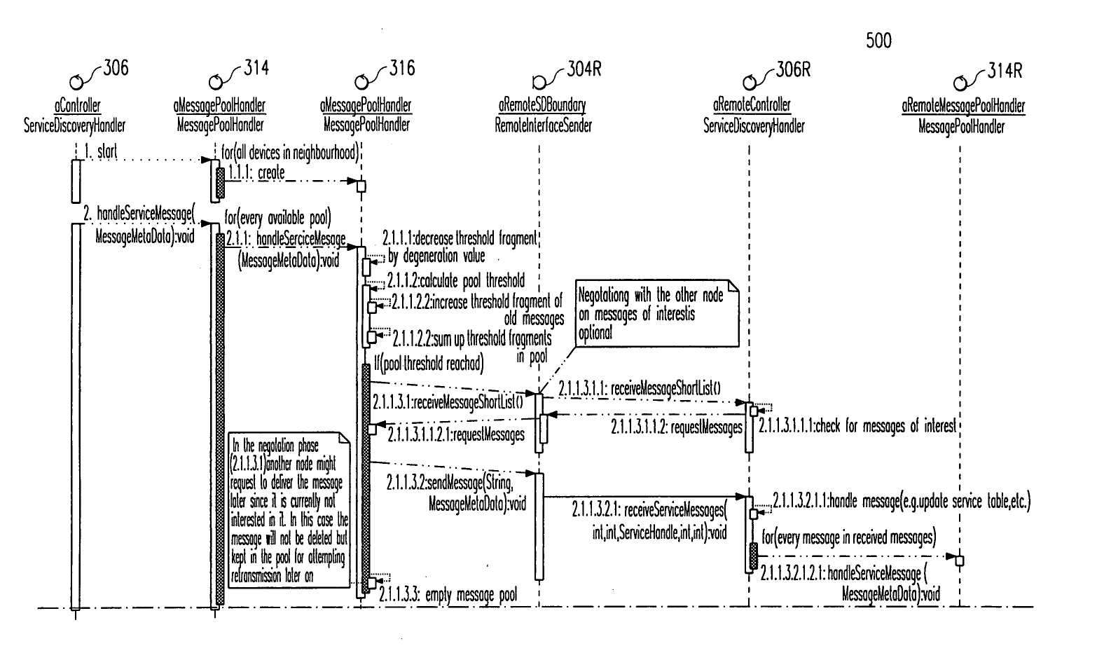

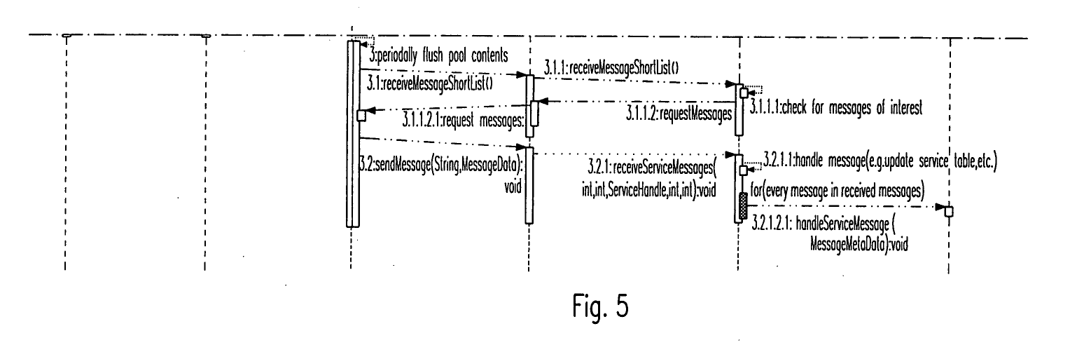

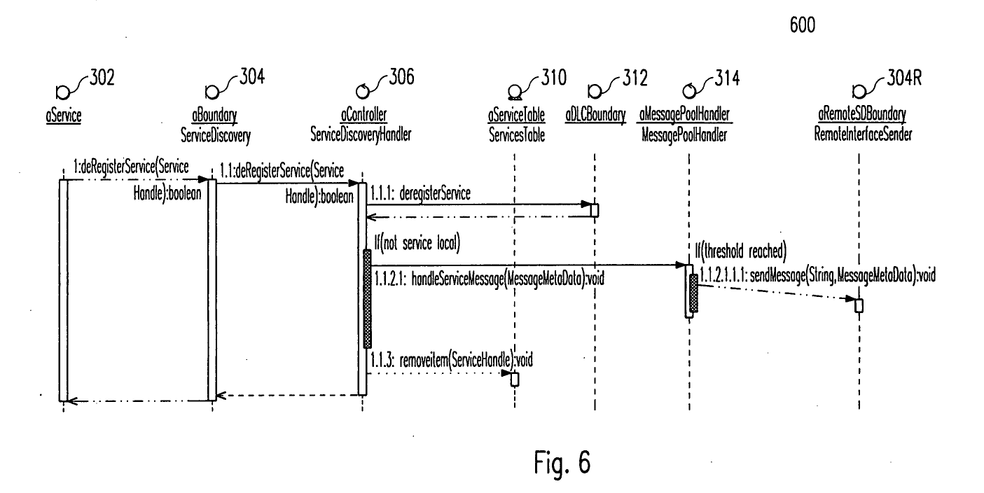

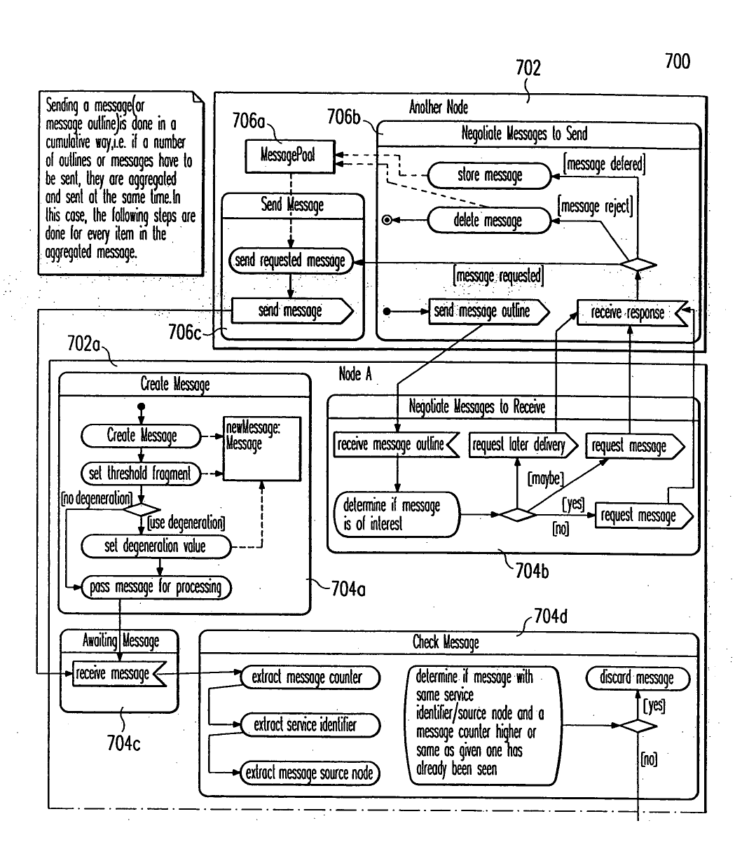

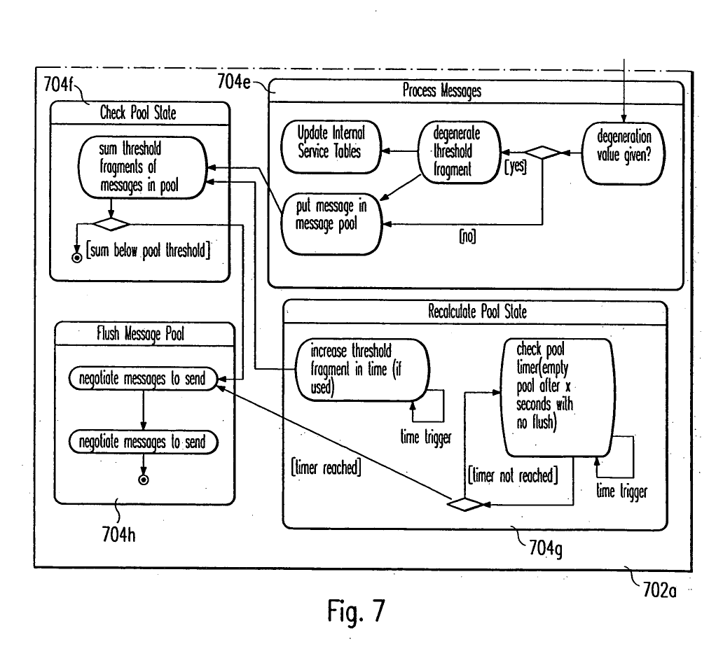

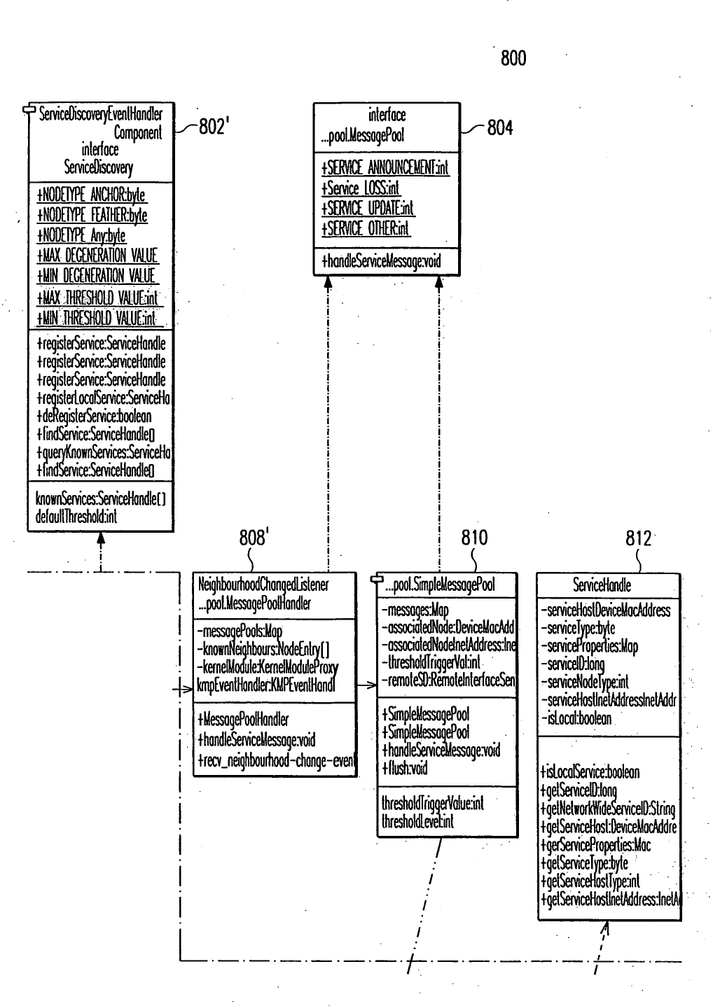

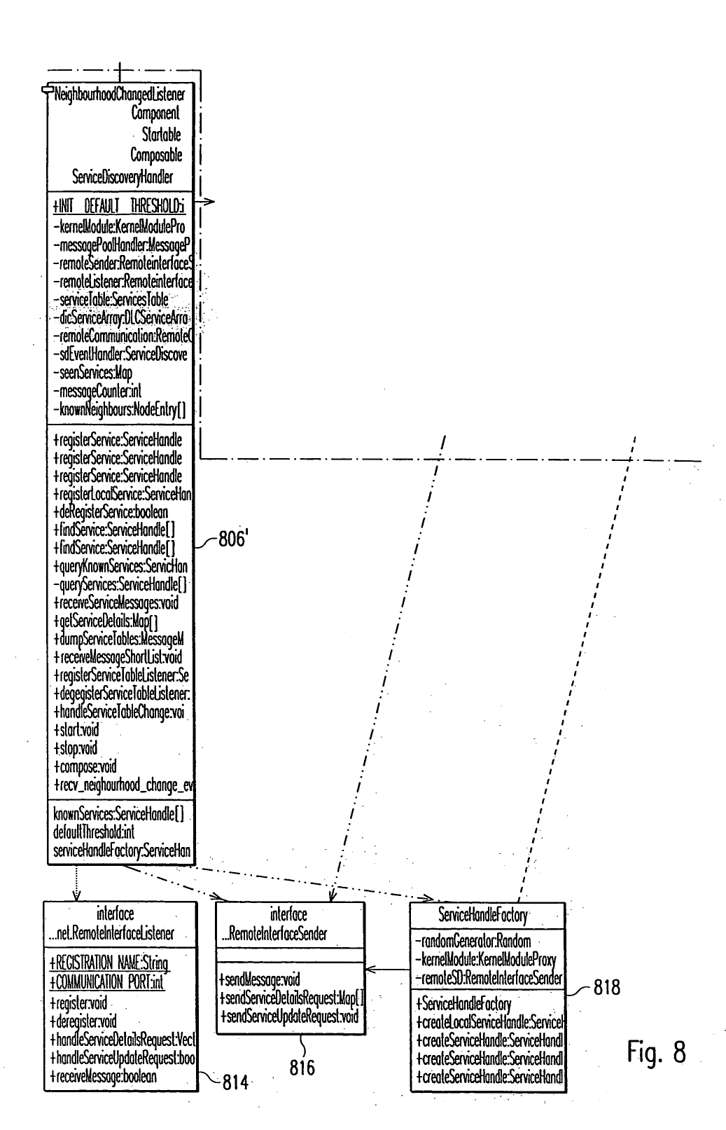

The procedures of registering a service, handling a service message indicating the availability of said service according to the present invention and deregistering the service are illustrated in the UML message sequence charts 300, 400, 500, and 600 depicted in FIGS. 3 to 6. An overview of the proposed service discovery mechanism executed by the service discovery protocol 208 according to the present invention is given by the UML state chart 700 depicted in FIG. 7. Finally, a UML class diagram 800 showing the classes for an object-oriented implementation of the service discovery protocol according to the present invention is depicted in FIG. 8.

The flexibility of the proposed service discovery protocol provides some degrees of freedom, some of which will subsequently be briefly discussed:
1. Any peer Nᵢ can locally decide when and how many announcement messages its service announcement message pool Pᵢ contains. Peers with power constraints such as mobile peers Nᵢ might have some larger pools Pᵢ to avoid sending too many messages Mᵢₖ while stationary peers Nⱼ might have small pools Pⱼ, thus forcing them to send more messages Mᵢₖ. Moreover, a threshold value R_{th,i} (R_{th,j}) for the cumulative relevance value Rᵢ (Rⱼ) can be set according to the current constraints of the respective mobile (Nᵢ) or stationary peer (Nⱼ). The value itself can be changed dynamically by the respective peer according to its current state.
2. With the possibility to have service announcement degeneration, available services are quickly announced in the immediate neighborhood of a peer Nᵢ (Nⱼ) but become only slowly visible at peers farther away.
3. Services which have to be made known to the entire network very quickly can be sent with a relatively high relevance value rᵢₖ (rⱼₖ); others can be sent with a lower one. In any case, the speed of spreading a service announcement message Mᵢₖ within the network can easily be controlled by peer Nᵢ (Nⱼ).
4. Fluctuations in the number of the peers forming said mobile multi-hop ad-hoc network can be used to trigger message exchanges and thus contribute to overall information dissemination.

It should be noted that neither of the given items and especially the combination of them can already be found in conventional service discovery protocols according to the state of the art.

The proposed protocol is specially tailored to the requirements of wireless multi-hop ad-hoc networks designed for operation in e.g. home environments and personal usage scenarios and features the following characteristics:
No broadcasting: In wireless multi-hop ad-hoc networks broadcasting is an expensive and power-consuming task (if it is possible at all). Hence, the proposed service discovery protocol can be seen as an enabling technology for service discovery in wireless multi-hop ad-hoc networks.
Sending no unnecessary messages, thus avoiding traffic overhead and preserving energy: This is especially of interest for mobile, battery-powered peers. The proposed protocol allows building devices that are less power-consuming by offering the same (or even better) functionality compared to the state of the art.
Keeping a very up-to-date view of the immediate neighborhood of a wireless peer (e.g. a television set located in the same room) and thus an enhanced user experience when utilizing this technology.

Utilizing functionality at lower layers and keeping the protocol rather simple allows easily integrating (at least some) functionality into hardware if required.

A further embodiment of the present invention pertains to a peer Nᵢ serving as a proxy server for providing service discovery information needed for determining the avail-ability of requested remote services in a peer-to-peer-based wireless multi-hop ad-hoc network based on a store-and-forward messaging principle. Thereby, said peer comprises a service discovery manager unit 204 for implementing a method as described above.

The invention finally pertains to a software program product designed to support a service discovery method as described above when running on this peer Nᵢ.

### Description of the Applied Terms

| Technical Term | Brief Explanation |
|---|---|
| Service | Service is any component within a network |
| | that exposes some interface. The interface |
| | must be accessible externally, i.e. from |
| | other processes and possibly from other |
| | peers within the network. The process of |
| | exposing the services is given by the |
| | utilized service discovery protocol and its |
| | implementation. |
| Service | Service Discovery describes the process of |
| Discovery (SD) | finding suitable services within the |
| | network. A service is matching a request if |
| | it fulfills some specification as given by |
| | the instance requesting the service |
| | discovery. This service specification might |
| | only be a simple service type, but could |
| | consist of a more complex description of the |
| | desired service by e.g. a list of attributes |
| | that has to be met. Details on how services |
| | are looked up are defined by the according |
| | service discovery protocol. |
| Target | Target environment is a wireless multi-hop |
| Environment | ad-hoc network tailored for operation in |
| | e.g. home environments and for personal use. |

### Depicted Features and their Corresponding Reference Signs

| No. | Technical Feature (System Component or Procedure Step) |
|---|---|
| 100 | table comparing different characteristic features, |
| | advantages and disadvantages of conventional service |
| | discovery mechanisms and protocols |
| 200 | diagram showing different peer protocol layers used for |
| | the handling of a metadata-based service description |
| | according to the present invention |
| 202 | application layer of said peer protocol for running client |
| | applications |
| 204 | intermediate protocol layer for a service discovery meta- |
| | data handler |
| 206 | interface between the service discovery protocol layer 208 |
| | and the application layer 202 as well as the intermediate |
| | protocol layer 204 for said service discovery metadata |
| | handler |
| 208 | service discovery protocol layer for determining the |
| | availability of requested remote services |
| 300 | UML message sequence chart showing the interactions for |
| | registering a remote service according to the present |
| | invention |
| 302 | element aService |
| 304 | element aBoundary, derived from the class ServiceDiscovery |
| | 802 |
| 304R | element aRemoteSDBoundary, derived from the class |
| | RemoteInterfaceSender 816 |
| 306 | element aController, derived from the class |
| | ServiceDiscoveryHandler 806 |
| 306R | element aRemoteController, derived from the class |
| | ServiceDiscoveryHandler 806 |
| 308 | element aServiceHandleFactory, derived from the class |
| | ServiceHandleFactory 818 |
| 310 | element aServiceTable, derived from the class ServiceTable |
| | (not shown) |
| 312 | element aDLCBoundary |
| 314 | element aMessagePoolHandler, derived from the class |
| | MessagePoolHandler 808 |
| 314R | element aRemoteMessagePoolHandler, derived from the class |
| | MessagePoolHandler 808 |
| 316 | element aMessagePoolImpl, derived from the class |
| | SimpleMessagePool 810 |
| 400 | UML message sequence chart showing the interactions for |
| | registering a local service according to the present |
| | invention |
| 500 | UML message sequence chart showing the interactions for |
| | handling a service message indicating the availability of |
| | a remote service according to the present invention |
| 600 | UML message sequence chart showing the interactions for |
| | deregistering a local or remote service according to the |
| | present invention |
| 700 | UML state chart illustrating the service discovery |
| | mechanism executed by the service discovery protocol 208 |
| | according to the present invention |
| 702a | a first peer (peer A) in a wireless multi-hop ad-hoc |
| | network |
| 702b | a second peer (peer B) in said wireless multi-hop ad-hoc |
| | network |
| 704a | state ,,Create Message,, of said first peer 702a (peer A) |
| 704b | state ,,Negotiate Message to Receive,, of the first peer |
| | 702a (peer A) |
| 704c | state ,,Awaiting Message,, of the first peer 702a (peer A) |
| 704d | state ,,Check Message,, of the first peer 702a (peer A) |
| 704e | state ,,Process Messages,, of the first peer 702a (peer A) |
| 704f | state ,,Check Pool State,, of the first peer 702a (peer A) |
| 704g | state ,,Recalculate Pool State,, of the first peer 702a |
| | (peer A) |
| 704h | state ,,Flush Message Pool,, of the first peer 702a (peer A) |
| 706a | message pool of said second peer 702b (peer B) |
| 706b | state ,,Negotiate Messages to Send,, of the second peer 702b |
| | (peer B) |
| 706c | state ,,Send Message,, of the second peer 702b (peer B) |
| 800 | UML class diagram showing the classes for an object-ori- |
| | ented implementation of the service discovery protocol |
| | according to the present invention |
| 802 | class ServiceDiscovery |
| 802′ | component ServiceDiscoveryEventHandler, derived from the |
| | class ServiceDiscovery 802 |
| 804 | class MessagePool, obtained by a generalization of the |
| | NeighborhoodChangedListener component 808 and the |
| | SimpleMessagePool class 810 |
| 806 | class ServiceDiscoveryHandler |
| 806′ | component NeighborhoodChangedListener, derived from the |
| | class ServiceDiscoveryHandler 806 |
| 808 | class MessagePoolHandler |
| 808′ | component NeighborhoodChangedListener, derived from the |
| | class MessagePoolHandler 808 |
| 810 | class SimpleMessagePool |
| 812 | class ServiceHandle |
| 814 | class RemoteInterfaceListener |
| 816 | class RemoteInterfaceSender |
| 818 | class ServiceHandleFactory |
| S0 | step #0: controlling the delivery of received service |
| | announcement messages Mᵢₖ referring to remote services |
| | offered by service providers within said network to its |
| | neighboring peers Nₗ by sorting (S2′) said messages Mᵢₖ |
| | according to their potential relevance rᵢₖ before being |
| | propagated (S4b) to said neighboring peers Nₗ and |
| | discarding (S1b) outdated and irrelevant messages Mᵢₖ |
| S1a | step #1a: receiving said service announcement messages Mᵢₖ |
| S1b | step #1b: discarding messages Mᵢₖ which are identical with |
| | old service announcement messages Mᵢₖ that have already |
| | been received by this peer Nᵢ |
| S1c | step #1c: accumulating new service announcement messages |
| | Mᵢₖ in a local message pool Pᵢ assigned to said peer Nᵢ |
| S2 | step #2: tagging each service announcement message Mᵢₖ |
| | received by this peer Nᵢ with a relevance value rᵢₖ |
| S3 | step #3: adding the relevance values rᵢₖ of all service |
| | announcement messages Mᵢₖ stored in said local message |
| | pool Pᵢ, thus yielding a cumulative relevance value Rᵢ |
| S4a | step #4a: once this cumulative relevance value Rᵢ exceeds |
| | a predefined relevance threshold value R_{th,i}, aggregating |
| | all service announcement messages Mᵢₖ stored in said local |
| | message pool Pᵢ |
| S4b | step #4b: sending the aggregated service announcement |
| | messages Mᵢₖ to all neighboring peers Nₗ of said peer Nᵢ |
| S4b′ | step #4b′: sending received and aggregated service |
| | announcement messages Mᵢₖ to all neighboring peers Nₗ in |
| | case the number Kᵢ of stored service announcement messages |
| | Mᵢₖ in the local message pool Pᵢ assigned to said first |
| | peer Nᵢ exceeds a certain number threshold K_{th,i} |
| S4b″ | step #4b″: sending received and aggregated service |
| | announcement messages Mᵢₖ to all neighboring peers Nₗ in |
| | case the time Δtᵢₖ passed since the reception of the last |
| | service announcement message Mᵢₖ exceeds a predefined time |
| | period threshold Δt_{th,i} |
| S5 | step #5: setting the relevance threshold values R_{th,i} of |
| | local message pools Pᵢ assigned to mobile peers Nᵢ to a |
| | higher value than the threshold values R_{th,j} of local |
| | message pools Pⱼ assigned to stationary peers Nⱼ |
| S6 | step #6: dynamically changing said relevance threshold |
| | value R_{th,i} according to external conditions |
| S6a | step #6a: determining whether a neighboring second peer |
| | Nₗ is running low on energy and/or other information |
| | concerning varying resource availability within said net- |
| | work and/or changing link characteristics between said |
| | peers Nᵢ and Nₗ |
| S6b | step #6b: if this is the case, increasing the relevance |
| | threshold value R_{th,i} of the according local message pool |
| | Pᵢ of said first peer Nᵢ to avoid sending unnecessary |
| | service announcement messages Mᵢₖ to said second peer Nₗ |
| S7 | step #7: recalculating the relevance values rᵢₖ of |
| | received service announcement messages Mᵢₖ by subtracting |
| | a percentage of degeneration given by a relevance |
| | degeneration rate dᵢₖ from the respective relevance value |
| | rᵢₖ, said degeneration rate dᵢₖ being the greater the |
| | greater the number of hops a service announcement messages |
| | Mᵢₖ has been propagated such that service announcement |
| | messages Mᵢₖ are quickly spread to near-by peers Nₗ but |
| | only slowly propagated to peers Nₗ farther away from the |
| | first peer Nᵢ |
| S8a | step #8a: monitoring the availability of neighboring peers |
| | Nₗ within said network |
| S8b | step #8b: in case a peer Nₗ is no longer present in the |
| | network and thus services hosted on that peer Nₗ are |
| | lost, propagating the loss of these service throughout the |
| | entire network |
| S9 | step #9: in case the content of the local message pool Pᵢ |
| | assigned to said first peer Nᵢ is sent to anyone of its |
| | neighboring peers Nₗ or to a multiplicity of them, |
| | supplying said neighboring peers Nₗ with a short outline |
| | of service announcement messages Mᵢₖ to be propagated, |
| | said outline including at least a service identifier, the |
| | address of a peer N_{H} hosting the service and a message |
| | identifier, such that a neighboring peer Nₗ receiving |
| | these data can decide whether said message Mᵢₖ is of |
| | particular interest to it or not |
| S10a | step #10a: proactively querying a local service table |
| | containing information on the availability of specific |
| | services of interest from a peer N_{H} hosting these services |
| S10b | step #10b: in case locally none is available, executing a |
| | service discovery protocol for providing service discovery |
| | information needed for determining the availability of the |
| | requested services within said multi-hop ad-hoc network |
| S10c | step #10c: once some services of interest are known, |
| | retrieving more detailed information on these services |
| S10d | step #10d: forwarding this information to all neighboring |
| | peers Nₗ |

1. A method for providing service discovery information and other data for determining the availability of requested remote services in a peer-to-peer-based wireless multi-hop ad-hoc network,
said method being characterized by the step of
delivering received service announcement messages referring to remote services offered by service providers within said network to neighboring peers and
discarding outdated and irrelevant messages.

2. A method according to claim 1,
characterized by said peer executing the following steps:
receiving said service announcement messages,
discarding messages which are identical with old service announcement messages that have already been received by this peer and accumulating new service announcement messages in a local message pool assigned to said peer,
tagging each service announcement message received by this peer with a relevance value,
adding the relevance values of all service announcement messages stored in said local message pool, thus yielding a cumulative relevance value, and,
once this cumulative relevance value exceeds a predefined relevance threshold value, aggregating all service announcement messages stored in said local message pool and sending them to all neighboring peers of said peer.

3. A method according to claim 2,
characterized by the step of
setting the relevance threshold values of local message pools assigned to mobile peers to a higher value than the threshold values of local message pools assigned to stationary peers.

4. A method according to claim 3,
characterized by the step of
dynamically changing said relevance threshold value according to external conditions.

5. A method according to claim 4,
characterized in that a first peer announcing available services within said network executes the steps of
determining whether a neighboring second peer is running low on energy and/or other information concerning varying resource availability within said network and/or changing link characteristics between said peers and,
if this is the case, increasing the relevance threshold value of the according local message pool of said first peer to avoid sending unnecessary service announcement messages to said second peer.

6. A method according to claim 5,
characterized by said first peer executing the step of sending received and aggregated service announcement messages to all neighboring peers in case the number of stored service announcement messages in the local message pool assigned to said first peer exceeds a certain number threshold.

7. A method according to claim 5,
characterized by said first peer executing the step of sending received and aggregated service announcement messages to all neighboring peers in case the time passed since the reception of the last service announcement message exceeds a predefined time period threshold.

8. A method according to claim 1,
characterized by said first peer executing the step of recalculating the relevance values of received service announcement messages by subtracting a percentage of degeneration given by a relevance degeneration rate from the respective relevance value, said degeneration rate being the greater the number of hops a service announcement messages has been propagated such that service announcement messages are quickly spread to near-by peers but only slowly propagated to peers farther away from said first peer.

9. A method according to claim 1,
characterized by said first peer executing the steps of
monitoring the availability of neighboring peers within said network and,
in case a peer is no longer present in the network and thus services hosted on that peer are lost, propagating the loss of these service throughout the entire network.

10. A method according to claim 1,
characterized in that said first peer,
in case the content of the local message pool assigned to said first peer is sent to anyone of its neighboring peers or to a multiplicity of them, supplies said neighboring peers with a short outline of service announcement messages to be propagated, said outline including at least a service identifier, the address of a peer hosting the service and a message identifier, such that a neighboring peer receiving these data can decide whether said message is of particular interest to it or not.

11. A method according to claim 1,
characterized by said first peer executing the steps of
proactively querying a local service table containing information on the availability of specific services of interest from a peer hosting these services,
in case locally none is available, executing a service discovery protocol for providing service discovery information needed for determining the availability of the requested services within said multi-hop ad-hoc network, and,
once some services of interest are known, retrieving more detailed information on these services and forwarding this information to all neighboring peers.

12. A software program product
designed to implement a method according to claim 1.
